(19) United States
(12) Patent Application Publication
(10) Pub. No.: US 2017/0124484 A1
(43) Pub. Date: May 4, 2017

(54) Machine Learning System

(71) Applicant: Wal-Mart Stores, Inc., Bentonville, AR (US)

(72) Inventors: John Paul Thompson, Bentonville, AR (US); Eric Anthony Letson, Bentonville, AR (US)

(21) Appl. No.: 15/335,010

(22) Filed: Oct. 26, 2016

Related U.S. Application Data
(60) Provisional application No. 62/249,667, filed on Nov. 2, 2015.

(51) Int. Cl. G06N 99/00; G06F 3/0484; G06N 5/02

(52) U.S. Cl. CPC G06N 99/005; G06N 5/02; G06F 3/0484

(57) ABSTRACT

Machine learning methods and systems are provided. A machine learning system receives item-descriptive data corresponding to a plurality of uncategorized items and programmatically associates, based on the item-descriptive data, each of the uncategorized items with a user account. The system compares, by a machine learning algorithm, the item-descriptive data with existing item-descriptive data corresponding to a number of previously categorized items and automatically decides to which of one or more item categories the uncategorized data should be assigned based on dynamically learned behavior, the one or more item categories being defined in the user account. The system automatically assigns, based on the comparison and decision, each of the plurality of uncategorized items to the one or more item categories to generate a plurality of newly categorized items and adds the automatic item category assignments and corresponding newly categorized items to the number of previously categorized items.

### CROSS-REFERENCE TO RELATED PATENT APPLICATIONS

This application is claims priority to U.S. Provisional Application No. 62/249,667 filed on Nov. 2, 2015, the content of which is hereby incorporated by reference in its entirety.

### BACKGROUND

Conventionally, categorizing item-descriptive data corresponding to uncategorized items requires manually categorizing each described item associated with each category. However, such manual categorization is time consuming and labor intensive. In some instances, automated categorization of data can be performed based on fixed or static parameters. While categorization of uncategorized items may be automated, such automation may not provide for categorization of data based on dynamically learned behaviors.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram showing a machine learning system in accordance with various embodiments.

FIG. 2 is a flow diagram illustrating a method performed by a machine learning system in accordance with various embodiments.

FIG. 3 is a flow diagram illustrating an example training process performed by the machine learning system in accordance with various embodiments.

FIG. 4 is a flow diagram illustrating an example prediction process performed by the machine learning system in accordance with various embodiments.

FIG. 5 is an example computational device block diagram depicting various components which can be used to implement various of the disclosed embodiments.

FIG. 6 is an example computational device block diagram depicting various components which can be used to implement various of the disclosed embodiments in a distributed system.

### DETAILED DESCRIPTION

As discussed above, categorizing item-descriptive data corresponding to uncategorized items conventionally requires manually categorizing each described item associated with each category. However, such manual categorization is time consuming and labor intensive. Additionally, conventionally, item-descriptive data can also correspond to pre-categorized items. However, such categories must be manually assigned and conform to generic, fixed categories, without customization or personalization.

Methods and systems are provided herein for automatically categorizing uncategorized data. The methods and systems, in accordance with various embodiments, are configured to assign, each of a plurality of uncategorized items to one or more categories defined in a user account by using a machine learning algorithm to compare received item-descriptive data corresponding to the plurality of uncategorized items with existing item-descriptive data corresponding to a plurality of previously categorized items and automatically decide to which category the uncategorized data should be assigned using dynamically learned behavior. Thereby, the systems and methods provided herein are able to advantageously provide automatic categorization of uncategorized data.

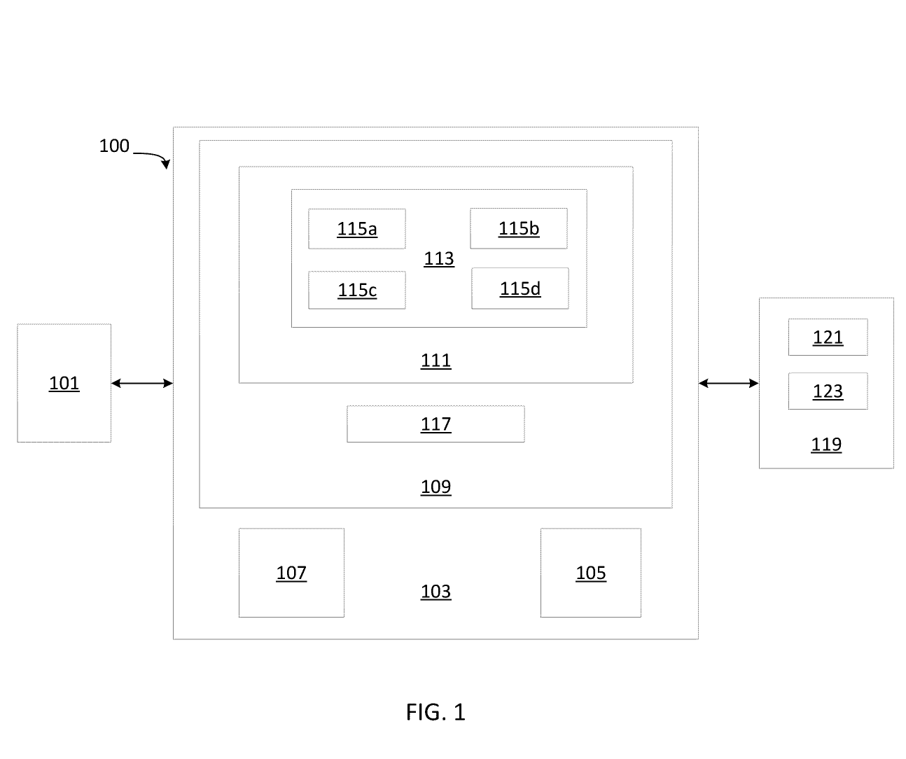

Referring now to FIG. 1, an exemplary machine learning system 100 for automatically categorizing uncategorized data includes a data reader 101 for acquiring and transmitting, directly or indirectly, item-descriptive data corresponding to each of a plurality of uncategorized items to a machine learning module 103. The machine learning module 103 includes a communications device 105 for receiving the transmitted item-descriptive data, a processor 107, and a memory 109 having stored thereon a user account database 111. The user account database 111 includes at least one user account 113, and each user account 113 can include one or more item categories 115a-d. The memory 109 also has stored thereon a machine learning algorithm 117 for comparing the received item-descriptive data with existing item-descriptive data corresponding to a plurality of previously categorized items and automatically deciding to which category the uncategorized data should be assigned using dynamically learned behavior. Based on the comparison and decision, the machine learning module 103 can automatically assign each of the uncategorized items to one or more of the item categories 115a-d defined in the user account 113.

Data reader 101 can be any device suitable for acquiring and/or transmitting item-descriptive data, including for example, an RFID reader, a NFC reader, a barcode reader, a digital camera, a mobile device, a magnetic strip reader, a point of sale terminal, any other suitable device, or combinations thereof. In accordance with various embodiments, the data reader 101 can include an integral transmitter or transceiver for transmitting the acquired item-descriptive data.

Machine learning module 103, in accordance with various embodiments, can be integrated in a common device with data reader 101 (e.g., as components of a mobile device) or can be implemented in a remote device (e.g., a remote server). The communication device 105 of the machine learning module 103, in accordance with various embodiments can include, for example, but is not limited to, a radio frequency (RF) receiver, RF transceiver, NFC device, a built-in network adapter, network interface card, PCMCIA network card, card bus network adapter, wireless network adapter, USB network adapter, modem or any other device suitable for interfacing with any type of network capable of communication and performing the operations described herein. Processor 107, in accordance with various embodiments can include, for example, but is not limited to, a microchip, a processor, a microprocessor, a special purpose processor, an application specific integrated circuit, a microcontroller, a field programmable gate array, any other suitable processor, or combinations thereof. Memory 109, in accordance with various embodiments can include, for example, but is not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

In use, the data reader 101 acquires and transmits item-descriptive data corresponding to a plurality of uncategorized items to the machine learning module 103. In some embodiments, the item-descriptive data can be selectively transmitted to the machine learning module 103. For example, transmission of the item-descriptive data to the machine learning module 103 can be predicated on satisfaction of transmission criteria, an ability to associate the uncategorized data with a user, capturing a machine-readable element associated with a plurality of items and encoded with known item-descriptive data for the plurality of items, and/or can be predicated on any other suitable actions, functions, or parameters. In accordance with various embodiments, the item-descriptive data transmitted to the machine learning module 103 can include user-identifying information for permitting programmatic association of the transmitted item-descriptive data with the user account 113 defined in the user account database 111 stored in the memory 109.

By way of non-limiting example, in one application of the technology described herein, the item-descriptive data can include identification and price information for each of a plurality of items purchased by a customer (e.g., consumer products or services), along with customer-identifying information for association with a user account 113 of the customer. For example, if the customer makes a purchase at a retail location, the data reader 101, in accordance with various embodiments, can be, for example but not limited to, a point of sale terminal (POS) having a barcode scanner and an optional credit card reader. The customer or cashier can use the barcode reader to scan one or more items and the customer can provide tender for purchasing the items. Thus the POS receives the item-descriptive data and associates that data with a particular purchase transaction. In accordance with various embodiments, each individual item included in a transaction can processed and categorized such that various embodiments provide for item-level categorization as opposed to transaction level categorization for which a transaction is categorized without individually analyzing and categorizing items included in the transaction. In accordance with various embodiments of the customer purchase data example, user-identifying data can be captured automatically by the POS at the time of purchase, for example, from a membership card, a check, a credit card, debit card, e-wallet, or electronic or customer-identifying tender presented as payment by the customer or from a non-tender account such as, for example, a customer loyalty account, customer rewards account, a social media account, a coupon club account, etc., applied to the purchase. In accordance with various embodiments of the customer purchase data example, the user-identifying data can be captured from an email address and/or a phone number provided by, or confirmed by, the customer at the time of purchase for the provision of an e-receipt or for receiving future promotional communication. Alternatively, the e-receipt can be transmitted to the provided email address or phone number (e.g., as a text message to a mobile device) and the customer can later associate the item-descriptive data of the e-receipt with the user account 113 via a user interface 121 of a user device 119.

It will be apparent in view of this disclosure that some forms of tender, such as cash or gift cards, are conventionally considered untraceable tenders. That is, a cash or gift card payment at the POS, without more, does not offer or include any user-identifying information to be captured. However, in accordance with various embodiments of the customer purchase data example, in the event that the customer provides untraceable tender as payment, a receipt provided by the POS can be later used to acquire the item-descriptive data for each item included in the transaction, the user-identifying data, or otherwise associate the item-descriptive data with the user account 113. In accordance with various embodiments, a data capture device 123 (e.g., a camera, barcode reader, optical scanner, printer scanner) of the user device 119 can be used to capture purchase transaction information, including item-descriptive data, on the receipt. The user device 119 can then be used to automatically associate the purchase transaction information with the user account 113 or permit the customer to manually associate the purchase transaction information with the user account 113 via the user interface 121 of the user device 119. The data capture device 123, in accordance with various embodiments, can capture the purchase transaction information from any relevant portion of the receipt, including for example, the header information, trailer information, line level details, unique transaction codes (e.g., one or more of printed characters, a bar code, or a QR code), or combinations thereof.

Upon receiving the item-descriptive data at the communications device 105, the machine learning module 103, by the processor 107, can interrogate the user account 113 to verify that a threshold number of previously categorized items exists within each item category 115a-d of the user account 113 to operate the machine learning algorithm 117. The machine learning algorithm can use the threshold to ensure that it has an adequate sample size from which learned behavior can be derived. The learned behavior can be captured in conditional behavior or logic structures of a decision model that can be used when making decisions as to which category or categories an unit of item descriptive data should be associated with. As more data is categorized, the conditional behavior or logic structures can be updated to dynamically update the learned behavior of the machine learning algorithm 117.

In accordance with various embodiments, the item categories 115a-d can be defined within the user account 113 prior to categorization of the uncategorized data. The item categories 115a-d can be entirely custom categories created by the user of the user account 113 and/or can be selected from one or more preset categories provided by the machine learning system 100. The user, in accordance with various embodiments, can further add, delete, merge, split, or modify categories associated with the user account 113 at any time via the user interface 121 of the user device 119 (e.g., a mobile device, desktop computer, any other suitable device). Thus, the user is able to advantageously define a tailored set of unique, custom categories on an as-needed basis for meeting particularized categorization needs. Further to the customer purchase data example above, the customer can define any set of categories based on pre-selectable categories, custom categories, and combinations therein. For example, the customer may wish to select one or more general department categories (e.g., hardware, grocery, and men's wear) and then create additional custom categories such as “necessaries,” “luxuries,” “living room decor,” “healthy food,” and “junk food.” It will be understood in view of this disclosure that any custom category, preselected category, or combination thereof can be created or selected in accordance with various embodiments.

If the number of previously categorized items is less than the threshold, the machine learning module 103 can store the item-descriptive data with the user account 113 for future manual categorization by the user. If the number of previously categorized items meets or exceeds the threshold, the machine learning module 103 can use the machine learning algorithm 117 to compare the received item-descriptive data to existing item-descriptive data corresponding to the previously categorized items and can automatically decide to which category the uncategorized data should be assigned using dynamically learned behavior. Machine learning algorithm 117 can include, for example but not limited to, a Naïve Bayes classifier, a support vector machine, a decision tree, a linear regression, a neural network, a logistic regression, a perceptron, a relevance vector machine, a Bayes optimal classifier, a bootstrap aggregating ensemble, a random forest, a boosting ensemble, a Bayesian model combination, a bucket of models ensemble, a stacking ensemble, and/or a supervised learning algorithm.

Based on the comparison and decision, the machine learning module 103 can automatically assign each of the plurality of uncategorized items to one or more of the item categories 115a-d defined in the user account 113 to transform the uncategorized items into a plurality of newly categorized items. The machine learning module 103 can then add the automatic item category assignments and corresponding newly categorized items to the number of previously categorized items associated with the user account 113. Thus, embodiments of the machine learning system 100 as described herein advantageously provide for automatic categorization of uncategorized data based on a user-defined, tailored set of unique, custom item categories 115a-d and dynamically learned behavior in response to the selective transmission of uncategorized data to the machine learning module 103.

In accordance with various embodiments, the user can, via the user interface 121 of the user device 119, advantageously review the automatic category assignments of any of the newly or previously categorized items associated with the user account 113. Thus, the user can advantageously perform post-processing analysis regarding the categorized data. Further to the retail purchase data example above, the customer can, in accordance with various embodiments, track total expenditures in each category, compare expenditures between each category, identify periodic purchasing habits for future planning, identify wasteful expenditures, or perform other analyses. Furthermore, via the user interface 121, the user can manually add, merge, split, delete, or otherwise modify categories and/or can add, merge, split, delete, or otherwise modify the automated category assignments for the categories to better match the user's preferences (i.e. move categorized data from one category to another category), thereby providing additional feedback for the machine learning algorithm 117. This feedback can be used by the machine learning module to modify or adapt learned behavior of the machine learning algorithm 117. For example, based on the changes to the categories and/or the categorization of the categorized data, the machine learning module 103 can automatically update the machine learning algorithm to improve automated categorization of future received item-descriptive data. For example, in some embodiments, the machine learning algorithm can include a decision model for each user account that includes dynamically created conditional behavior or logic structures that can be used when making decisions as to which category or categories an unit of item descriptive data should be associated with. When the user moves categorized data from one category to another, the machine learning module 103 can automatically modify the conditional behavior or logic structures in the decision model that can be used by the machine learning module 103 to improve future categorization.

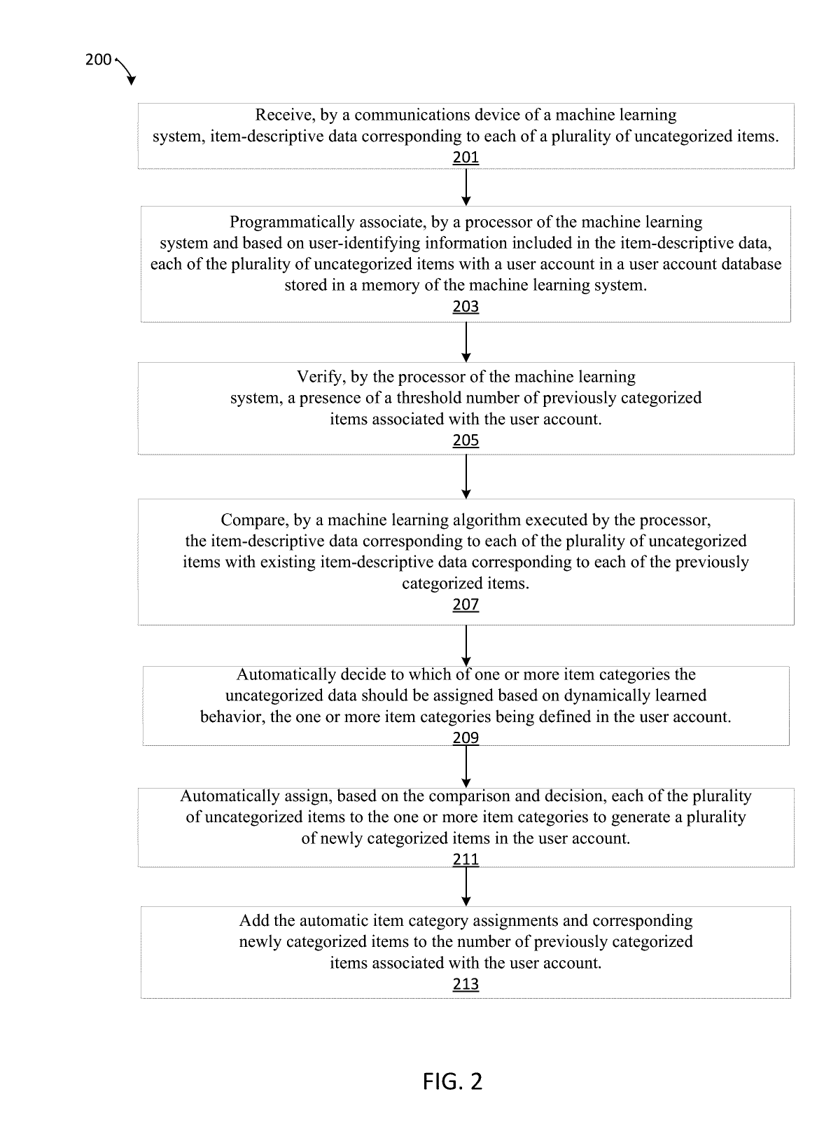

Referring now to FIG. 2, a method 200 is provided that is performed by embodiments of the machine learning system. The method includes a step 201 of receiving, by a communications device of the machine learning system, item-descriptive data corresponding to each of a plurality of uncategorized items, and a step 203 of programmatically associating, by a processor of the machine learning system and based on user-identifying information included in the item-descriptive data, each of the plurality of uncategorized items with a user account in a user account database stored in a memory of the machine learning system. In some embodiments, the item-descriptive data can be selectively transmitted to the machine learning module 103. At step 205, the method includes verifying, by the processor of the machine learning system, a presence of a threshold number of previously categorized items associated with the user account and at step 207, the method includes comparing, by a machine learning algorithm executed by the processor, the item-descriptive data corresponding to each of the plurality of uncategorized items with existing item-descriptive data corresponding to each of the previously categorized items. At step 209, the method includes automatically deciding to which category the uncategorized data should be assigned using dynamically learned behavior. At step 211, the method includes automatically assigning, based on the comparison and decision, each of the plurality of uncategorized items to one or more item categories defined in the user account to generate a plurality of newly categorized items and at step 213 the method includes adding the automatic item category assignments and corresponding newly categorized items to the number of previously categorized items associated with the user account.

The step of receiving, by a communications device of a machine learning system, item-descriptive data corresponding to each of a plurality of uncategorized items 201 can be performed, for example but not limited to, using communications device 105 of machine learning module 103 as described above with reference to FIG. 1.

The step of programmatically associating, by a processor of the machine learning system and based on user-identifying information included in the item-descriptive data, each of the plurality of uncategorized items with a user account in a user account database stored in a memory of the machine learning system 203 can be performed, for example but not limited to, using the processor 107 of the machine learning module 103 to associate user-identifying information in the item-descriptive data with the user account 113 of the user account database 111 stored in the memory 109 as described above with reference to FIG. 1.

The step of verifying, by the processor of the machine learning system, a presence of a threshold number of previously categorized items associated with the user account 205 can be performed, for example but not limited to, using the processor 107 of the machine learning module 103 to verify a threshold number of previously categorized items exist in each of the plurality of categories 115a-d defined in the user account 113 of the user account database 111 stored in the memory 109 reference to FIG. 1.

The step of comparing, by a machine learning algorithm executed by the processor, the item-descriptive data corresponding to each of the plurality of uncategorized items with existing item-descriptive data corresponding to each of the previously categorized items 207 and deciding to which category the uncategorized data should be assigned using dynamically learned behavior can be performed, for example but not limited to, using the processor 107 to compare the received item-descriptive data to the existing item-descriptive data and deciding to which category the uncategorized data should be assigned using the machine learning algorithm 117 as described above with reference to FIG. 1.

The step of automatically assigning, based on the comparison and decision, each of the plurality of uncategorized items to one or more item categories defined in the user account to generate a plurality of newly categorized items 209 and the step of adding the automatic item category assignments and corresponding newly categorized items to the number of previously categorized items associated with the user account 211 can be performed, for example but not limited to, using the machine learning module 103 to assign each of the plurality of uncategorized items to one or more of the item categories 115a-d defined in the user account 113 of the user account database 111 in the memory 109 as described above with reference to FIG. 1.

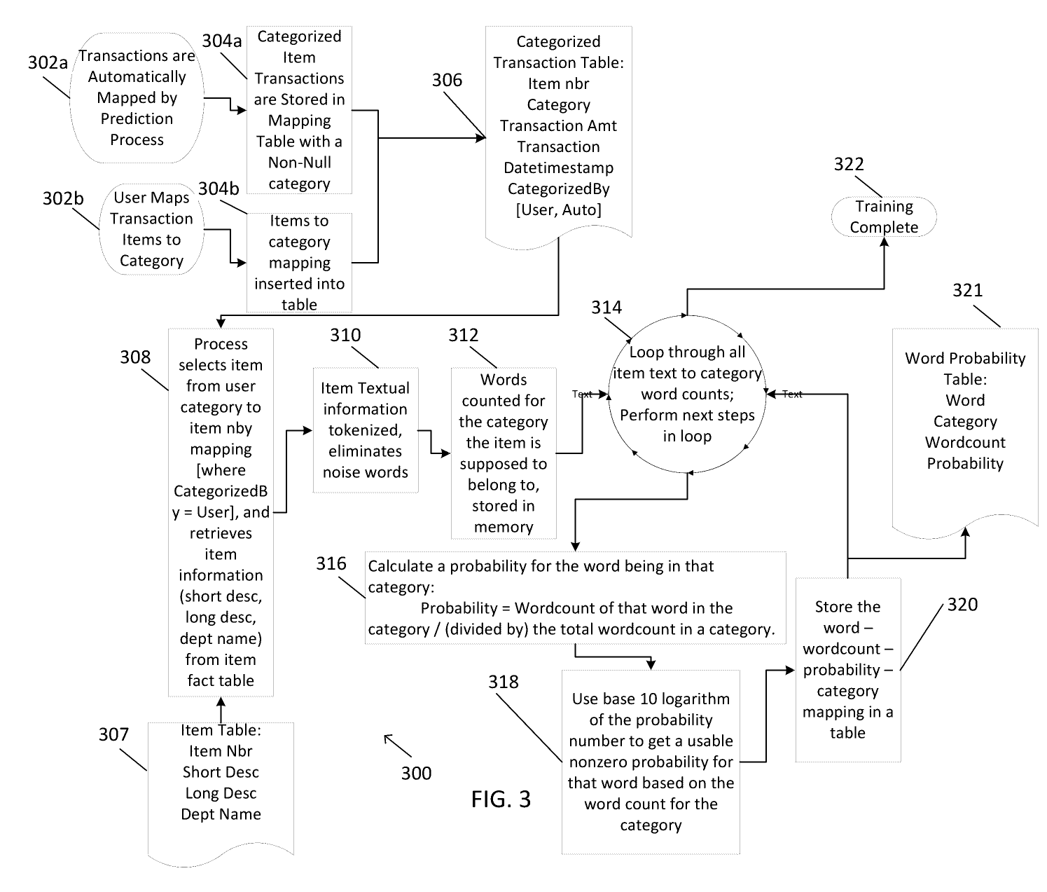

FIG. 3 is a flow diagram illustrating an example training process 300 performed by the machine learning system 100 in accordance with various embodiments. The example training process 300 is described with reference to an application of an exemplary embodiment the machine learning system 100 to categorizing data in the form of items purchased by a customer. The training process can be being at step 302a and/or 302b. As one example, at step 302a, individual items in a transaction can be automatically and separately mapped to a category, and at step 304a, categorized items are stored in a mapping table. As another example, at step 302b, individual items in a transaction can be manually and separately mapped to categories by the customer, and at step 304b, an items-to-category mapping is stored in the mapping table. At step 306, a categorized transaction table is updated based on each item included in the transaction, the category associated with the item, an amount/price associated with the item or the transaction, a timestamp for the transaction, and a categorized-by parameter to indicate whether the item was categorized automatically by the system or manually by the customer. At step 308, for each item categorized by the customer, the system 100 retrieves item information including one or more descriptions of the item, department name(s) associated with the item, and the like, from an item table 307 associated with the item. For example, an item may be “1234” and may have been mapped to the category “candy” by the user, and the information retrieved from the item table can include: a short description (e.g., “candy corn 3 lbs.”); a long description (“Chewy candy corn gummy candies with classic candy corn flavor. The yellow, orange, and white soft candies are perfect for Halloween snacking”); and a department name (“candy and gum”).

At step 310, the system 100 can tokenize the words included in the item information and eliminate/remove noise or extraneous words that may not be useful in training or classifying items. The normalization process can convert words found in the item information into standardized forms. For example, continuing with the example using item “1234”, the system can identify the following tokens.

Tokens:

3

And

Are

Candies

Candies

Candy

Candy

Candy

Candy

Chewy

Classic

Corn

Corn

Corn

Flavor

For

Gum

Gummy

Halloween

Lbs.

Orange

Perfect

Snacking

Soft

The

White

With

Yellow

The system 100 can remove the noise words: “3”, “and”, “are”, “for”, “the”, and “with” from the list of identified tokens. At step 313, the system can count the quantity of times that each taken is included in the list of tokens (e.g., a word count) and associates the tokens with the category assigned by the user (e.g., “candy”). As an example, the system 100 can create the following list of tokens based on the identified tokens after the noise words are removed.

Tokens Word Count:

Candies, 2

Candy, 4

Chewy, 1

Classic, 1

Corn, 3

Flavor, 1

Gum, 1

Gummy, 1

Halloween, 1

Lbs., 1

Orange, 1

Perfect, 1

Snacking, 1

Soft, 1

White, 1

Yellow, 1

At step 314, the system 100 loops through the tokens for the item categorized by the user to train the system 100. For each token identified by the system 100, the system calculates a probability for the token being in the assigned category at step 316. For example, continuing with the example for item “1234”, the system can calculate the probability using the following mathematical expression:

Probability=wordcount(token)/total_wordcount

where wordcount(token) corresponds to the quantity of times a token is found in the token list and total_wordcount denote the sum of all identified tokens. For the above example, the token “candies” occurs twice and there is a total word count of twenty two tokens. Therefore, the probability that the word “candies” is associated with the category Candy is the quotient of two divided by twenty two. At step, 318, for each token, the system 100 uses a base 10 logarithm of the token's probability (Log(probability)) to obtain a useable nonzero probability for the token based on the word count for the category. At step 320, the token, word count for the token, the probability (after using the base 10 logarithm), and the category mapping are stored in a word probability table 321. The process continues to loop through steps 314-320 until the system processes all of the tokens identified by the system (excluding noise words). After the system completes all of the tokens, the process ends at step 322 and training is complete.

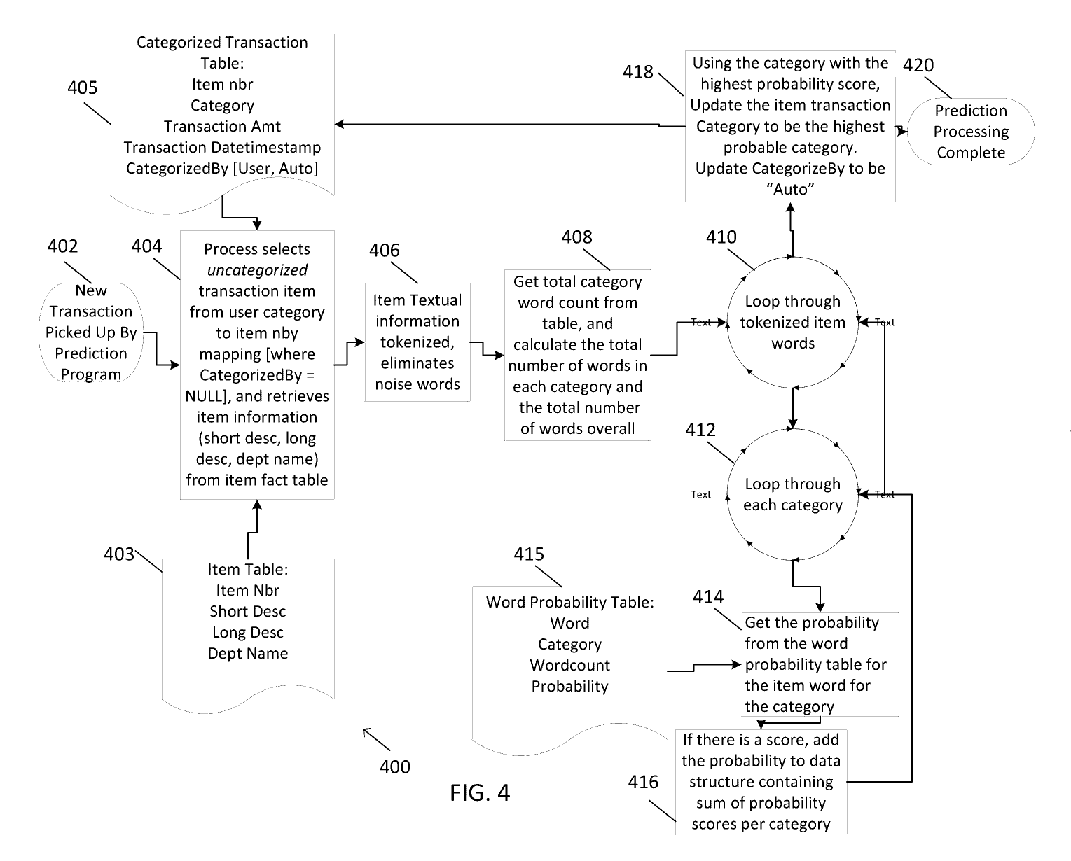

FIG. 4 is a flow diagram illustrating an example prediction process performed by the machine learning system in accordance with various embodiments. The example prediction process 400 is described with reference to an application of an exemplary embodiment the machine learning system 100 to categorizing data in the form of items purchased by a customer. At step 402, the system receives as an input a new transaction including one or more items. At step 404, the system 100 selects uncategorized items and retrieves item information for each item from an item table 403. As described herein, the item information can include one or description for the item, an item identifier, a department name, and the like. At step 406, the item information is tokenized and noise or extraneous words are eliminated or removed. At step 408, the system 100 obtains a total category word count from a category table and calculates a total number of words in each category and a total number of words overall. At step 410, for each token, the system loops through a prediction loop including steps 412, 414, and 416. At step 412, the system performs a sub-loop, where, for each token, the system 100 loops through the categories, and for each token and each category, the system 100 retrieves the probability for each token and each category from the word probability table 415. At step 416, the system adds the probability for each token and each category to a data structure containing a sum of probabilities for each category. After the loop is complete such that each token is evaluated against each category, the system continues at step 418 to select the category for the item that has the highest probability score and updates the categorized-by parameter to automatic. The newly assigned category and the updated categorized-by parameter are added to the categorized transaction table 405, and the predicting process 400 is complete at step 420.

### Exemplary Computing Devices

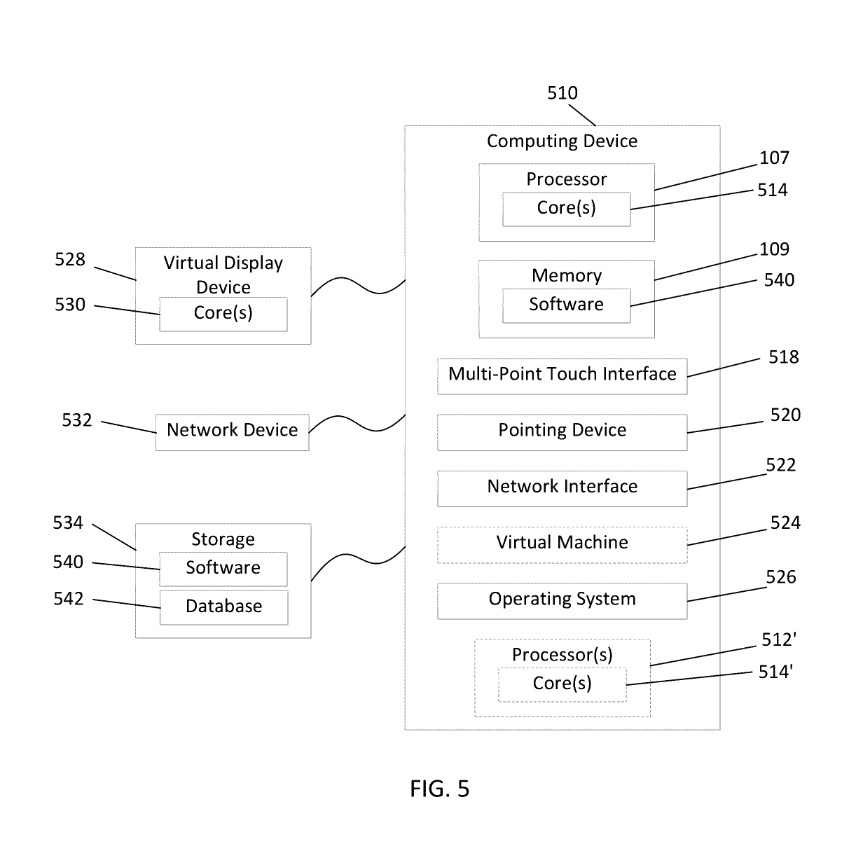

FIG. 5 is a block diagram of an exemplary computing device 510 such as can be used, or portions thereof, in accordance with various embodiments and, for clarity, refers back to and provides greater detail regarding various elements of the system 100 of FIG. 1. The computing device 510 can include one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives), and the like. For example, memory 109 included in the computing device 510 can store computer-readable and computer-executable instructions or software for performing the operations disclosed herein. For example, the memory 109 can store a software application 540 which is configured to perform various of the disclosed operations (e.g., compare received item-descriptive data with existing item-descriptive data using a machine learning algorithm 117 and automatically assigning each uncategorized item to one or more item categories 115a-d). The computing device 510 can also include configurable and/or programmable processor 107 and an associated core 514, and optionally, one or more additional configurable and/or programmable processing devices, e.g., processor(s) 512′ and associated core(s) 514′ (for example, in the case of computational devices having multiple processors/cores), for executing computer-readable and computer-executable instructions or software stored in the memory 109 and other programs for controlling system hardware. Processor 107 and processor(s) 512′ can each be a single core processor or multiple core (514 and 514′) processor.

Virtualization can be employed in the computing device 510 so that infrastructure and resources in the computing device can be shared dynamically. A virtual machine 524 can be provided to handle a process running on multiple processors so that the process appears to be using only one computing resource rather than multiple computing resources. Multiple virtual machines can also be used with one processor.

Memory 109 can include a computational device memory or random access memory, such as DRAM, SRAM, EDO RAM, and the like. Memory 109 can include other types of memory as well, or combinations thereof.

A user can interact with the computing device 510 through a visual display device 528, such as any suitable device capable of rendering texts, graphics, and/or images including an LCD display, a plasma display, projected image (e.g. from a pico projector), Google Glass, Oculus Rift, Hololens, and the like, and which can display one or more user interfaces 530 that can be provided in accordance with exemplary embodiments. The computing device 510 can include other I/O devices for receiving input from a user, for example, a keyboard or any suitable multi-point touch (or gesture) interface 518, a pointing device 520 (e.g., a mouse). The keyboard 518 and the pointing device 520 can be coupled to the visual display device 528. The computing device 510 can include other suitable conventional I/O peripherals.

The computing device 510 can also include one or more storage devices 534, such as a hard-drive, CD-ROM, flash drive, or other computer readable media, for storing data and computer-readable instructions and/or software that perform operations disclosed herein. In some embodiments, the one or more storage devices 534 can be detachably coupled to the computing device 510. Exemplary storage device 534 can also store one or more software applications 540 for implementing processes of the machine learning system described herein and can include databases 542 for storing any suitable information required to implement exemplary embodiments. The databases can be updated manually or automatically at any suitable time to add, delete, and/or update one or more items in the databases. In some embodiments, at least one of the storage device 534 can be remote from the computing device (e.g., accessible through a communication network) and can be, for example, part of a cloud-based storage solution.

The computing device 510 can include a network interface 522 configured to interface via one or more network devices 532 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X0.25), broadband connections (for example, ISDN, Frame Relay, ATM), wireless connections, controller area network (CAN), or some combination of any or all of the above. The network interface 522 can include a built-in network adapter, network interface card, PCMCIA network card, card bus network adapter, wireless network adapter, USB network adapter, modem or any other device suitable for interfacing the computing device 510 to any type of network capable of communication and performing the operations described herein. Moreover, the computing device 510 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 510 can run any operating system 526, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 526 can be run in native mode or emulated mode. In an exemplary embodiment, the operating system 526 can be run on one or more cloud machine instances.

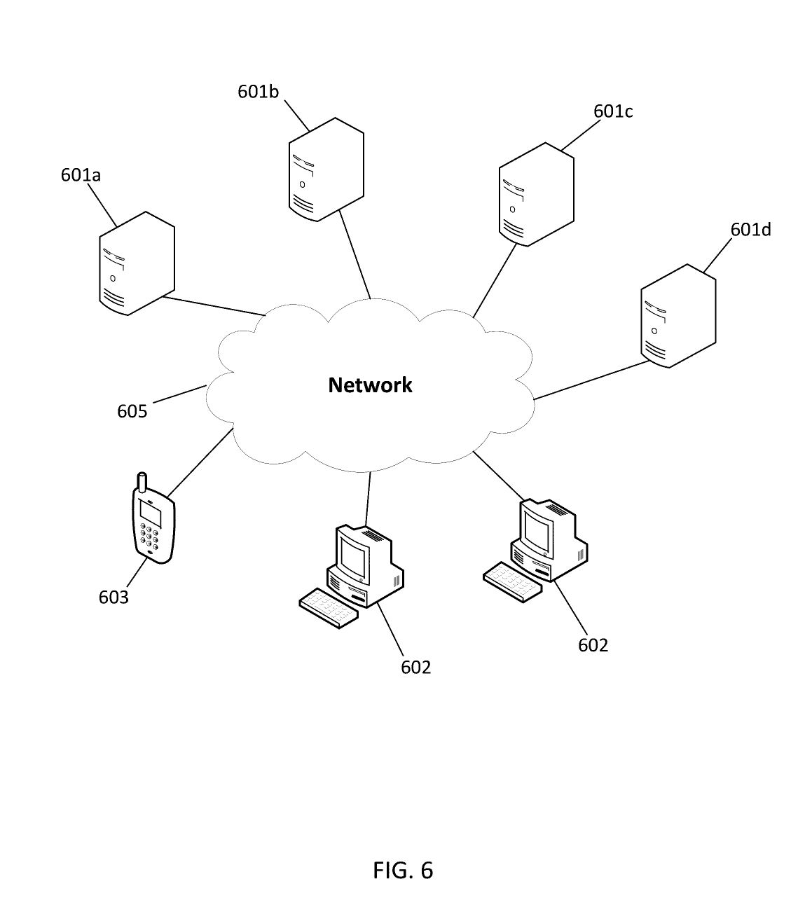

FIG. 6 is an example computational device block diagram of certain distributed and/or cloud-based embodiments. Although FIG. 1, and portions of the exemplary discussion above, make reference to a centralized machine learning system 100 operating on a single computing device, one will recognize that various of the modules within the machine learning system 100 may instead be distributed across a network 605 in separate server systems 601a-d and possibly in user systems, such as a desktop computer device 602, or mobile computer device 603. As one example, users may download an application to their desktop computer device or mobile computer device, which is configured to run the machine learning module 103. As another example, the user interface 121 can be a client side application of a client-server environment (e.g., a web browser or downloadable application, such as a mobile app), wherein the machine learning module 103 is hosted by one or more of the server systems 601a-601d (e.g., in a cloud-based environment) and interacted with by the desktop computer device or mobile computer device. In some distributed systems, the modules of the system 100 can be separately located on server systems 601a-d and can be in communication with one another across the network 605.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A machine learning system comprising:
a data reader configured to acquire and transmit item-descriptive data corresponding to each of a plurality of uncategorized items; and
a machine learning module in electronic communication with the data reader and including instructions stored in a memory that when executed by a processor cause the machine learning module to:
receive, by a communications device of the machine learning module, the electronic item-descriptive data transmitted by the data reader,
programmatically associate, based on user-identifying information included in the item-descriptive data, each of the plurality of uncategorized items with a user account in a user account database stored in the memory of the machine learning module,
verify a presence of a threshold number of previously categorized items associated with the user account,
compare, by a machine learning algorithm executed by the processor, the item-descriptive data corresponding to each of the plurality of uncategorized items with existing item-descriptive data corresponding to each of the previously categorized items,
automatically decide to which of one or more item categories the uncategorized data should be assigned based on dynamically learned behavior, the one or more item categories being defined in the user account;
automatically assign, based on the comparison and decision, each of the plurality of uncategorized items to the one or more item categories to generate a plurality of newly categorized items in the user account, and
add the automatic item category assignments and corresponding newly categorized items to the number of previously categorized items associated with the user account.

2. The system of claim 1, further comprising a user device configured to:
display the automatic item category assignments for each of the newly categorized items within a user interface of the user device; and
permit a user to modify one or more of the automatic item category assignments within the user interface.

3. The system of claim 2, wherein the instructions, when executed by the processor, further cause the machine learning module to:
receive, from the user via the user interface, instructions to modify one or more of the automatic item category assignments corresponding to at least one of the newly categorized items; and
modify the automatic item category assignment in response to the user instructions; and
add the modified item category assignment and corresponding newly categorized item to the number of previously categorized items associated with the user account.

4. The system of claim 1, wherein the instructions, when executed by the processor, further cause the machine learning module to:
display previous item category assignments for each of the previously categorized items within a user interface of a user device; and
permit a user to modify one or more of the previous item category assignments within the user interface.

5. The system of claim 4, wherein the instructions, when executed by the processor, further cause the machine learning module to:
receive, from the user via the user interface, instructions to modify one or more of the previous item category assignments corresponding to at least one of the previously categorized items;
modify the previous item category assignment in response to the user instructions; and
add the modified item category assignment and corresponding previously categorized item to the number of previously categorized items associated with the user account.

6. The system of claim 1, wherein the instructions, when executed by the processor, further cause the machine learning module to permit the user, via a user interface of a user device, to at least one of add, remove, or modify the one or more item categories defined in the user account.

7. The system of claim 1, wherein the machine learning algorithm includes at least one of a Naïve Bayes classifier, a support vector machine, a decision tree, a linear regression, a neural network, a logistic regression, a perceptron, a relevance vector machine, a Bayes optimal classifier, a bootstrap aggregating ensemble, a random forest, a boosting ensemble, a Bayesian model combination, a bucket of models ensemble, a stacking ensemble, or a supervised learning algorithm.

8. A method performed by a machine learning system, the method comprising:
receiving, by a communications device of the machine learning system, item-descriptive data corresponding to each of a plurality of uncategorized items;
programmatically associating, by a processor of the machine learning system and based on user-identifying information included in the item-descriptive data, each of the plurality of uncategorized items with a user account in a user account database stored in a memory of the machine learning system;
verifying, by the processor of the machine learning system, a presence of a threshold number of previously categorized items associated with the user account;
comparing, by a machine learning algorithm executed by the processor, the item-descriptive data corresponding to each of the plurality of uncategorized items with existing item-descriptive data corresponding to each of the previously categorized items;
automatically deciding to which of one or more item categories the uncategorized data should be assigned based on dynamically learned behavior, the one or more item categories being defined in the user account, at least one of the item categories corresponding to a user-defined item category;
automatically assigning, based on the comparison and decision, each of the plurality of uncategorized items to the one or more item categories to generate a plurality of newly categorized items in the user account; and
adding the automatic item category assignments and corresponding newly categorized items to the number of previously categorized items associated with the user account.

9. The method of claim 8, further comprising:
displaying the automatic item category assignments for each of the newly categorized items within a user interface of a user device; and
permitting a user to modify one or more of the automatic item category assignments within the user interface.

10. The method of claim 9, further comprising:
receiving, from the user via the user interface, instructions to modify one or more of the automatic item category assignments corresponding to at least one of the newly categorized items;
modifying, by the processor of the machine learning system, the automatic item category assignment in response to the user instructions; and
adding the modified item category assignment and corresponding newly categorized item to the number of previously categorized items associated with the user account.

11. The method of claim 8, further comprising:
displaying previous item category assignments for each of the previously categorized items within a user interface of a user device; and
permitting a user to modify one or more of the previous item category assignments within the user interface.

12. The method of claim 11, further comprising:
receiving, from the user via the user interface, instructions to modify one or more of the previous item category assignments corresponding to at least one of the previously categorized items;
modifying, by the processor of the machine learning system, the previous item category assignment in response to the user instructions; and
adding the modified item category assignment and corresponding previously categorized item to the number of previously categorized items associated with the user account.

13. The method of claim 8, further comprising permitting the user, via a user interface of a user device, to at least one of add, remove, or modify the one or more item categories defined in the user account.

14. The method of claim 8, wherein the machine learning algorithm includes at least one of a Naïve Bayes classifier, a support vector machine, a decision tree, a linear regression, a neural network, a logistic regression, a perceptron, a relevance vector machine, a Bayes optimal classifier, a bootstrap aggregating ensemble, a random forest, a boosting ensemble, a Bayesian model combination, a bucket of models ensemble, a stacking ensemble, or a supervised learning algorithm.

15. A non-transitory computer-readable medium having instructions stored thereon that, when executed by a processor, cause a machine learning system to:
receive, by a communications device of the machine learning system, item-descriptive data corresponding to each of a plurality of uncategorized items;
programmatically associate, based on user-identifying information included in the item-descriptive data, each of the plurality of uncategorized items with a user account in a user account database stored in a memory of the machine learning system;
verify a presence of a threshold number of previously categorized items associated with the user account;
compare, by a self-learning categorization algorithm executed by the processor, the item-descriptive data corresponding to each of the plurality of uncategorized items with existing item-descriptive data corresponding to each of the previously categorized items;
automatically decide to which of one or more item categories the uncategorized data should be assigned based on dynamically learned behavior, the one or more categories being defined in the user account;
automatically assign, based on the comparison, each of the plurality of uncategorized items to the one or more item categories to generate a plurality of newly categorized items in the user account; and
add the automatic item category assignments and corresponding newly categorized items to the number of previously categorized items associated with the user account.

16. The non-transitory computer-readable medium of claim 15, wherein the instructions further cause the machine learning system to:
display the automatic item category assignments for each of the newly categorized items within a user interface of a user device;
permit a user to modify one or more of the automatic item category assignments within the user interface;
receive, from the user via the user interface, instructions to modify one or more of the automatic item category assignments corresponding to at least one of the newly categorized items;
modify the automatic item category assignment in response to the user instructions; and
add the modified item category assignment and corresponding newly categorized item to the number of previously categorized items associated with the user account.

17. The non-transitory computer-readable medium of claim 15, wherein the instructions further cause the machine learning system to:
display previous item category assignments for each of the previously categorized items within a user interface of a user device; and
permit a user to modify one or more of the previous item category assignments within the user interface;
receive, from the user via the user interface, instructions to modify one or more of the previous item category assignments corresponding to at least one of the previously categorized items;
modify the previous item category assignment in response to the user instructions; and
add the modified item category assignment and corresponding previously categorized item to the number of previously categorized items associated with the user account.

18. The non-transitory computer-readable medium of claim 15, wherein the instructions further cause the machine learning system to permit the user, via a user interface of a user device, to at least one of add, remove, or modify the one or more item categories defined in the user account.
